(19) United States
(12) Patent Application Publication
(10) Pub. No.: US 2025/0381833 A1
(43) Pub. Date: Dec. 18, 2025

(54) Powertrain Control System and Method for a Mobile Machine

(71) Applicant: Caterpillar Inc., Peoria, IL (US)

(72) Inventors: Michael D. Beyer, Chillicothe, IL (US); Aditya Bhandari, Peoria, IL (US); Christopher J. Gebhart, Washington, IL (US)

(73) Assignee: Caterpillar Inc., Peoria, IL (US)

(21) Appl. No.: 18/745,180

(22) Filed: Jun. 17, 2024

(51) Int. Cl. B60K 6/52; B60K 6/543

(52) U.S. Cl. CPC B60K 6/52; B60K 6/543

(57) ABSTRACT

A mobile machine includes a powertrain having a primary transmission connected to a primary axle and a secondary transmission connected to a secondary axle. To regulate operation of the powertrain, the mobile machine is associated with a powertrain control system. The powertrain control system receives data inputs and powertrain characteristics and predictively estimates if nonsynchronous shift will occur with the primary transmission. The powertrain control system adjusts a secondary power output of the secondary transmission in response to and concurrently with the nonsynchronous shift.

### TECHNICAL FIELD

The present disclosure relates generally a powertrain for a mobile machine and more particularly to a system and method for regulating shifting in a powertrain having primary and secondary transmissions.

### BACKGROUND

Mobile machines used in industries such as construction, landscaping, mining and agriculture are equipped with powertrains that transmit motive power generated by a power source such as an internal combustion engine to a driven element, such as wheels or a work implement, for application. The motive force is transmitted through rotating shafts and can be characterized in terms of torque and/or rotational speed. The powertrain can include components to redirect and/or adjust the characteristics the motive force

For example, a transmission is a common powertrain component that can change the input and output ratios of the torque and rotational speed. Traditional transmissions include a series of fixed engageable gear ratios that change the speed and in an inverse relation the torque within in predetermined ranges. To operate the mobile machine in different ranges, the engaged gear ratios of the transmission must be physically changed, for example, by operator selection or in response to operating conditions.

Alternatively, some mobile machines utilize continuously variable transmissions (CVTs) that provide a continuous range of torque-to-speed output ratios with respect to any given input from the power source. A CVT is not normally associated with specific, discrete gear ratios to determine or control its output. In some embodiments, however, the physical configuration of the CVT must be physically changed to enable operation across the full continuous range of power transmission. Furthermore, in some cases, the CVT may be associated with a plurality of distinct selectable virtual gear ratios that mimic the traditional fixed gear transmissions for operator convenience and familiarity.

In either embodiment, when the powertrain experiences a gear shift, the transmission of motive power may be temporarily affected. For example, U.S. Pat. No. 8,568,271 describes a powertrain including a CVT that may experience shifting in response to changes in the power and torque requirements. To predict and reduce the effects on the transfer of motive power, the '271 patent describes a method of predicting possible shifts and resolves a condition referred to as shift hunting wherein the powertrain repeatedly or improperly reconfigures the transmission. The present application is also directed to a system and method for regulating shifting in a powertrain for a mobile machine.

### SUMMARY

The disclosure describes, in one aspect, a powertrain for a mobile machine in which a power source generate and transmits motive power to a primary axle to a primary traction/propulsion device for propelling the mobile machine over a terrain surface. To adjust the motive power applied to the primary axle, the powertrain include a primary transmission operatively coupled between the power source and the primary axle. The powertrain also include a secondary axle operatively coupled to a secondary traction/propulsion device and a secondary transmission operatively coupled to the secondary axle for directing a secondary power output thereto. To regulate operation of the powertrain, an electronic controller is included and configured to receive one or more data inputs, analyze the one or more data inputs to predictively estimate if a nonsynchronous shift will occur with the primary transmission, and command the secondary transmission to adjust the secondary power output concurrently with the nonsynchronous shift.

In another aspect, the disclosure describes a method of operating a powertrain of a mobile machine that has a first transmission and a second transmission. The method involves receiving a plurality of data inputs corresponding to a plurality of input devices operatively associated with the mobile machine and predictively estimating a nonsynchronous shift that will occur with the first transmission. In response to predicting a nonsynchronous shift, the method preemptively adjusts a secondary power output from the secondary transmission concurrently with the nonsynchronous shift of the primary transmission.

In yet another aspect of the disclosure, there is described a powertrain control process for operating a powertrain of the mobile machine. The powertrain control process transmits a primary power output from a primary transmission of a powertrain to a primary axle coupled to a primary traction/propulsion device of the mobile machine. The powertrain control process can receive one or more data inputs from a plurality of input devices associated with powertrain and can predictively estimating whether a nonsynchronous shift will occur with the primary transmission based on the one or more data inputs. In response to predicting that a nonsynchronous shift will occur, the powertrain control process can adjust a secondary power output from a secondary transmission of to a secondary axle coupled to a secondary traction/propulsion device of the mobile machine concurrently with nonsynchronous shift, thereby eliminating the power interruption.

### BRIEF DESCRIPTION OF THE DRAWINGS

FIG. 1 is a schematic diagram of a mobile machine in the embodiment of a motor grader equipped with a powertrain having primary and secondary transmissions.

FIG. 2 is a block diagram of a control system for a powertrain that can receive a plurality of data inputs and generate output commands in response to a nonsynchronous shift.

FIG. 3 is a flow diagram of a possible method for regulating operation of a powertrain having primary and secondary transmission to predict and resolve power interruptions associated with nonsynchronous shifts.

### DETAILED DESCRIPTION

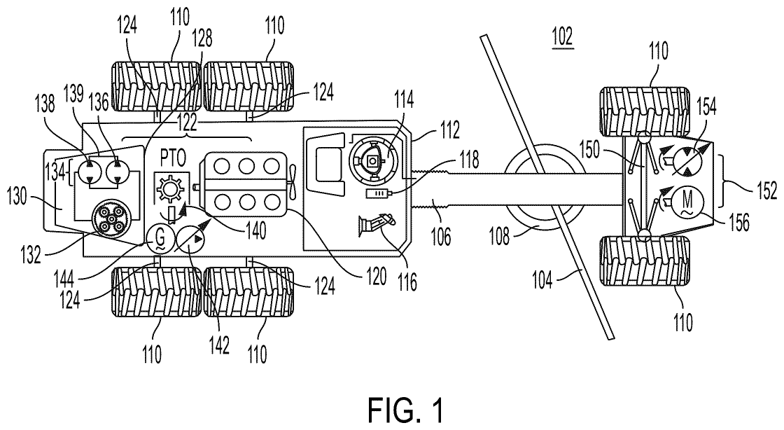

Now referring to the drawings, wherein whenever possible like reference numbers refer to like features, there is illustrated in FIG. 1 an embodiment of a mobile machine 100 configured for travel over a terrain surface 102 while conducting an earth working operation. In the illustrated embodiment, the mobile machine 100 is a motor grader equipped with a long blade 104 used to flatten or shape the terrain surface 102 into a desired topology as the mobile machine 100 travels. The blade 104 can be suspended from a machine frame 106 to hang proximate to and contact the terrain surface 102 on which the mobile machine 100 travels. The blade 104 and the machine frame 106 can be constructed from rigid structural steel components integrally connected together to accommodate and withstand the stresses and forces encountered during operation. The blade 104 can be operatively connected to the machine frame 106 through an adjustable linkage assembly 108 for spatial adjustment of the blade position with respect to the terrain surface 102.

While the illustrated mobile machine 100 is a motor grader, in accordance with the disclosure the mobile machine can be any type of machine that performs some operation associated with an industry such as mining, construction, farming, transportation, or any other industry known in the art. Moreover, an implement may be connected to the machine. Such implements may be utilized for a variety of tasks, including, for example, loading, compacting, lifting, brushing, and include, for example, buckets, compactors, fork lifting devices, brushes, grapples, cutters, shears, blades, breakers/hammers, augers, and others. For example, the machine may be an carth-moving machine, such as a wheel loader, excavator, dump truck, backhoe, motor grader, material handler or the like. Additionally, the machine may be used in the transportation field such as on-highway trucks, cargo vans, or the like.

To enable the mobile machine 100 to move and travel over the terrain surface 102, the machine frame 106 can be suspended upon a plurality of traction/propulsion devices 110. In an embodiment, the traction/propulsion devices 110 can be pneumatic tires that are located toward the front and rear of the mobile machine 100 and that can rotate with respect to the machine frame 106 thereby moving the mobile machine over the terrain surface 102. To propel the mobile machine 100 in the desired direction, at least one set of the traction/propulsion devices 110 may be power driven to rotate while a second set may be steerable, for example, by tilting alignment with respect to the machine frame 106. The traction/propulsion devices 110 may also be continuous tracts or belts that can translate with respect to the machine frame 106 by a combination of drive sprockets and idlers.

To direct operation of the mobile machine 100, an operator stations 112 or operator cab can be located on the machine frame 106 at a location to provide visibility over the terrain surface 102. Located in the operator station 112 can be various controls and/or inputs with which the operator can interact to maneuver and operate the mobile machine 100. For example, to steer and guide the travel direction of the mobile machine 100, a steering control 114 such as a steering wheel can be located in the operator station 112. Additionally, one or more implement controls 116, embodied as joysticks, for controlling operation of the blade 104 may be included in the operator station 112. The speed and travel velocity of the mobile machine 100 can also be controlled by one or more depressible pedals 118 that an operator can actuate with their foot. Examples of pedals include an accelerator to increase the travel velocity and a brake to slow or stall the mobile machine 100. The operator station 112 can also include various other readouts, dials, displays, and screens with which the operator can interface to communicate operational information regarding the activities of the mobile machine 100.

While the onboard operator station 112 can be intended to accommodate an operator for conventional manual operation of the mobile machine 100, in other embodiments, the mobile machine 100 can be configured for remote, semi-autonomous, or fully autonomous operation. Remote operation may also occur remotely wherein the operator is located off board the mobile machine 100 and operation is controlled through a remote control transmitter and wireless communication techniques. In autonomous operation, the mobile machine 100 can operate responsively to information about the operating and environmental conditions of the worksite provided from various sensors by selecting and executing various determined responses to the received information. An autonomous mobile machines 100 may include a computerized control system comprising hardware and software configured to make independent decisions based on programmed rules and logic. The control system uses sensor input about the machine environment, visions systems, etc., to control propulsion and steering in accordance with guidance controls, worksite or haul route information, and the assigned tasks or operations. In semi-autonomous operation, an operator either onboard or working remotely may control the machine to conduct some tasks and operations, while others are conducted automatically in response to information received from sensors.

To generate motive power for operation of the mobile machine 100, a power source 120 can be located on the machine frame 106. The power source 120 for example can be an internal combustion engine such as a compression ignition diesel engine that burns a hydrocarbon-based fuel or another combustible fuel source to convert the potential or chemical energy therein to mechanical power that may be utilized for other work. Another example of a suitable power source 120 can be a spark-ignition gasoline combusting engine. In possible embodiments, the power source 120 can utilized stored or generated electrical energy to drive one or more electrical motors operatively associated with the traction/propulsion devices 110 and/or the blade 104 or other work implement. For example, the power source 120 can include a plurality of rechargeable batteries, fuel cells, or an electric generator to create motive power for operation of the mobile machine 100.

To transmit the generated motive power from the source to the point of application, the power source 120 can be operatively associated with a powertrain 122. The powertrain 122 can include various components such as drive shafts, differentials, and transmissions that redirect and adjust the motive force from the power source 120 into a state or condition for use by the various applications of the mobile machine 100. For example, the powertrain 122 can include a primary axle 124 or pair of axles that is operatively associated with the rearward set of traction/propulsion devices 110 on the machine frame 106. The primary axle 124 can be traverse to the longitudinal extension of the machine frame 106 and, accordingly, to the direction of travel of the mobile machine 100. The primary axle 124 can be an elongated shaft that is rotationally attached to the machine frame 106 by bearings and fixedly coupled to the traction/propulsion devices 110, which may also be referred to as the final drive. Rotation of the primary axle 124 with respect to the machine frame 106 thus also rotates the traction/propulsion devices 110 with respect to the terrain surface 102 resulting in powered propulsion of the mobile machine 100.

The application of the motive force at the traction/propulsion devices 110, in terms of torque and/or rotational speed, may differ from that generated by the power source 120. For example, it may be desirable to operate the power source 120 within a particular operational band or range and adjust the generated motive force in terms of torque and/or rotational speed through the powertrain 122. To adjust the generated motive force, the powertrain 122 can include a primary transmission 128 operatively disposed between the power source 120 and the primary axle 124 that, for example, may be capable of modifying the torque-to-speed ratio in a controlled manner.

In an embodiment, the primary transmission 128 can be a continuously variable transmission or CVT. A CVT can provide a continuous range of torque-to-speed output ratios with respect to any given input from the power source 120. In other words, the output of the CVT may be increased or decreased across a continuous range in immeasurably small increments and thus, a CVT does not engage specific, discrete gear ratios to determine or control its output.

In the illustrated embodiment, the CVT associated with the primary transmission 128 can be a split-path hydromechanical transmission 130 in which the rotational input from the power source 120 is split into parallel paths and recombined prior to delivery to the primary axle 124. The paths can include a mechanical power transfer path 132 and a hydrostatic power transfer path 134. The mechanical power transfer path 132 includes one or more engageable gear sets in which the intermeshing gears are selectively engaged to increase or decrease the input ratio to output ratio of torque and speed through the primary transmission 128. The mechanical power transfer path 132 may also include a planetary gear set that produces a variety of different output, including reversible outputs, by changing the relative speeds that the different gears rotate with respect to each other. The mechanical power transfer path 132 can also include a plurality of fixed gear sets with predetermined gear ratios that can be selectively engaged by clutches.

The hydrostatic power transfer path 134 can utilize fluid mechanics principles to change the input to output ratios of the motive force. For example, the hydrostatic power transfer path 134 can include a hydraulic pump 136 and a hydraulic motor 138 interconnected by a fluid transfer line 139 such as a flexible hydraulic hose that may channel hydraulic fluid. The hydraulic pump 136, which may be a variable displacement pump, swash plate, or the like, may be operatively coupled to the output of the power source 120 and may convert the rotary power input to hydraulic pressure by pressurizing the hydraulic fluid 139 in the fluid transfer line 139. The fluid transfer line directs the pressurized hydraulic fluid to the hydraulic motor 138 to rotate an associated impeller and reconvert the hydraulic pressure to a rotational output. By varying the displacement of the hydraulic pump 136 and/or the resistance to fluid flow within the fluid transfer line 139, the rotational output speed and torque of the hydraulic motor 138 is consequentially changed.

The adjusted motive force output by the mechanical power transfer path 132 and a hydrostatic power transfer path 134 can be recombined and transmitted to the primary axle 124 and onward to the traction/propulsion devices 110, for example, through a differential. In an embodiment of a CVT, the primary transmission 128 can have other suitable configurations for the adjustable transmission of motive power such as a belt and pulley configuration, an electromagnetic configuration including a generator-motor combination wherein a variable electrical resistance can be adjusted to change the power transmission, and other suitable designs for a CVT. Further, the mechanical and/or hydrostatic power transfer paths 132, 134 may be configured to receive and utilize or dissipate regenerative power from the primary axial 124.

To provide power for other applications and systems on the mobile machine 100, the powertrain 122 can include one or more auxiliary power takeoffs (PTOs) 140 that diverts the motive power transmitted from the power source 120. The PTOs 140 may be located and operably connected between the power source 120 and the primary transmission 128. The PTO 140 can include gears, shafts, and splines that are rotationally driven by the powertrain 122 and that are operatively coupled with other powered implements for operation of the mobile machine 100. For example, the mobile machine 100 can include a hydraulic system and the PTO 140 can be operatively coupled to a hydraulic pump 142 which pressurizes and directs the flow of hydraulic fluid in response to receiving rotational force from the power source 120. The mobile machine 100 can also include an electrical system and the PTO 140 can be operatively coupled to an electric generator 144 that can generate electricity in response to the application of rotary force from the power source 120. The hydraulic and/or electrical power created by the hydraulic pump 142 and the electric generator 144 can be transmitted about the mobile machine 100 by electrical and fluid conduits extended and distributed over the machine frame 106.

To improve traction of the mobile machine 100 with respect to the terrain surface 102, the mobile machine 100 can be configured to deliver and apply the motive force to the total plurality of the traction/propulsion devices 110. For example, the rotational output by the power source 120 can be diverted to the primary axle 124 operatively coupled to the traction/propulsion devices 110 located proximate to the rear end of the machine frame 106 and to a secondary axle 150 operatively coupled with the traction/propulsion devices 110 that may be located on the front end of the machine frame 106. The secondary axle 150 can also be a shaft that is rotationally attached by bearings to the machine frame 106 to allow relative rotation of the structures and thus powered rotation of the forward traction/propulsion devices 110 to apply tractive force to the terrain surface 102.

In an embodiment, the powertrain 122 can be operatively connected with the secondary axle 150 by drive shafts and transfer gear sets for direct mechanically connection. Alternatively, the secondary axle 150 can be operatively associated with a secondary transmission 152 that receives motive power from the power source 120 indirectly. For example, if the mobile machine 100 includes a hydraulic system, the secondary transmission 152 can include a hydraulic motor 154 that is fluidly connected with the hydraulic pump 142 to receive pressurized hydraulic fluid there from. The hydraulic motor 154 is configured to convert the energy embodied by the fluid pressure to mechanical power and rotational motion, for example, through a spinning impeller. If the mobile machine 100 includes an electrical system, the secondary transmission 152 can include an electrical motor 156 that is electrically connected with the electrical generator 144 and that can convert electrical energy into mechanical rotation characterized by torque and rotational speed.

The indirect connection between the secondary transmission 152 and the other components of the powertrain 122 can be advantageous if the machine frame 106 is articulated so that the forward and rearward traction/propulsion devices 110 can be angularly displaced with respect to each other, or in other embodiments wherein the machine frame 106 is complex and incapable of supporting the necessary drive shafts. A further advantage of having the powertrain 122 separately associated with distinct primary and secondary transmissions 128, 152 is that the primary and secondary transmissions can independently adjust the motive power received from the power source 120. The overall power generated by the mobile machine 100 can be selectively distributed and delivered to the primary and secondary axles 124, 150 in response to changing operating conditions and can thus maximize the traction applied between the plurality of traction/propulsion devices 110 and the terrain surface 102. Decoupling the primary and secondary transmissions 128, 152 from each other allows the components to be individually adjusted and operated in response to the changing conditions experienced by the mobile machine.

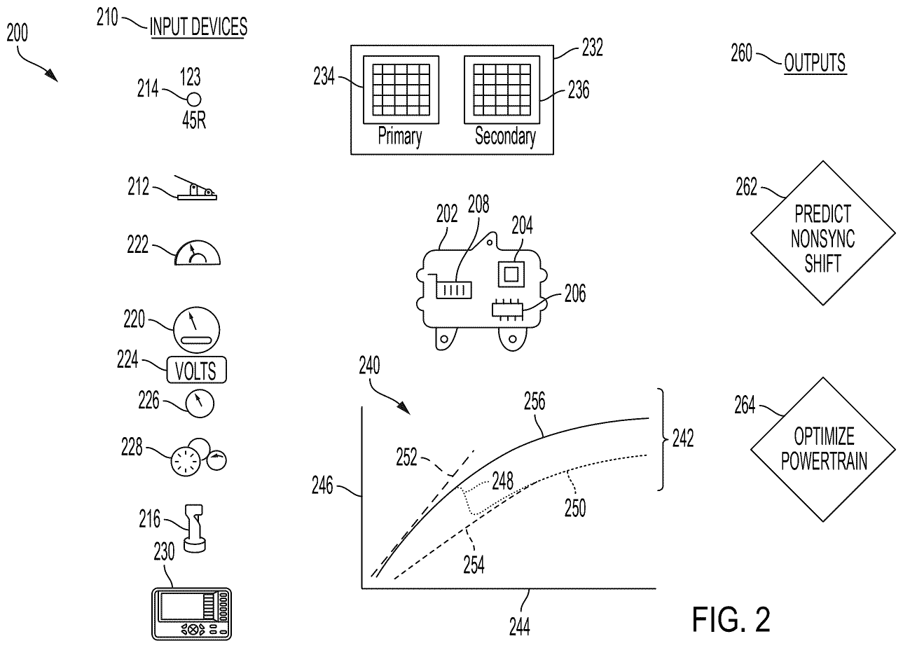

Referring to FIG. 2, to operatively regulate the allocation of motive power between the primary and secondary axles 124, 150, the powertrain 122 can be operatively associated with an electronic control system, referred to as the powertrain control system 200. The powertrain control system 200 can be a computer implemented arrangement in which data and information is obtained regarding the operation of the mobile machine 100 and is logically processed for machine control. The powertrain control system 200 can utilize logical rules, predetermined definitions and categorization routines, and casual relations that can be applied through the execution of sequential algorithms to determine, among other outputs, the operative settings and commands for the primary and second transmission 128, 152.

The powertrain control system 200 can be physically implemented though an electronic controller 162, also referred to as a control module or control unit. The electronic controller 202 can be physically located onboard the mobile machine 100 or some components and functionality can occur remotely off board. Moreover, the electronic controller 202 can be physically configured as a unitary unit, or its associated components and functionality can be distributed among different discrete devices. The electronic controller 202 can be responsible for regulating and controlling operation of other systems associated with the mobile machine 100 in addition to the powertrain 122.

The electronic controller 202 can be a programmable computing device and can include one or more microprocessors 204 for executing software programming instructions and processing computer readable data. Examples of suitable microprocessors include programmable logic devices such as field programmable gate arrays (“FPGA”), dedicated or customized logic devices such as application specific integrated circuits (“ASIC”), gate arrays, a complex programmable logic device, or any other suitable type of circuitry or microchip. The processor 204 can include the appropriate arithmetic and control logic circuitry and associated registers for conducting digital logic operations.

To store application software and data, the electronic controller 202 can include a non-transitory computer readable and/or writeable data memory 206 or similar data storage that can be embodied, for example, as read only memory (“ROM”), random access memory (“RAM”), EPROM memory, flash memory, etc. Data memory 206 can also be operatively associated with and utilize more permanent forms of secondary data storage such as magnetic hard drives. The data memory 206 is capable of storing software in the form of computer executable programs including instructions, definitions, and electronic data for the operation of the mobile machine. The programs can include equations, algorithms, charts, maps, lookup tables, databases, and the like.

To interface and network with the other components and operational systems on the mobile machine 100, the electronic controller 202 can include an input/output interface 208 to electronically send and receive non-transitory data and information. The input/output interface 208 can be physically embodied as data ports, serial ports, parallel ports, USB ports, jacks, and the like to communicate via conductive wires, cables, optical fibers, or other communicative components that may be part of a communication bus or otherwise networked. The input/output interface 208 can communicatively transmit data and information embodied as electronic signals or pulses through physical transmission media such as conductive wires or as optical pulses through fiber optics. Communication can also occur wirelessly through the transmission of radio frequency signals. Communication can occur via any suitable communication protocol for data communication including sending and receiving digital or analog signals synchronously, asynchronously, or elsewise.

To obtain data and information needed for regulating operation of the powertrain 122, the powertrain control system 200 can be associated with a plurality of input devices 210 that are communicatively connected with the input/output interface 208 of the electronic controller 202. The input devices 210 can be active devices, for example, subject to physical manipulation by an operator resulting in responsive control commands directed to the electronic controller 202. The input devices 210 may be passive devices such as sensors configured to monitor and/or measure one or more operating conditions or physical states. Examples of sensory techniques include electrical conditions such as voltage and conductivity, mechanical conditions including force and pressure sensors, chemical sensors, optical and/or acoustic sensors, etc. The input devices 210 may generate responsive electronic data signals that are communicated to the electronic controller 202 for processing and evaluation.

By way of example, the input devices 210 can include a machine velocity control 212, which may typically be embodied as a foot actuated, depressible accelerator pedal although can also be implemented as a lever or slider. The machine velocity control 212 can be actuated to receive a commanded or desired travel velocity or speed of the mobile machine 100 with respect to the terrain surface 102. The travel velocity can be changed by, for example, adjusting the running speed of the power source 120 or by adjusting the configuration of the powertrain 122 to increase or decrease the rotational speed transmitted there through.

In a related example, to adjust the configuration of the primary transmission 128 that is operatively coupled to the primary axle 124, the input devices 210 can include a gearshift 214 or gear selector. An operator can use the gearshift 214 to selectively engage the different gear ratios of the primary transmission 12. The gearshift 214 can be used to intentionally increase the speed and/or torque being applied by the propulsion/traction devices 110 coupled to the primary axle 124. For example, due to the inverse relation, the gearshift 214 can command the primary transmission 128 to engage lower gear ratios and increase the rim pull torque applied by the primary axle 124 but reducing the rotational speed. In the embodiments wherein the primary transmission 128 is a CVT, the gearshift 214 can be associated with a plurality of virtual gear ratios for appropriately configuring the primary transmission in response to desired or commanded performance.

The input devices 210 can also include an implement control 216 embodied as a joystick or similar manipulable input. An operator can us the implement control 216 to operatively engage the blade 104 or another work implement with the terrain surface 102. Operative engagement of the work implement typically increases the power requirements of the mobile machine 100. For example, depending upon the angular positions of the blade 104 with respect to the terrain surface 102, the blade may be displacing greater quantities of material. Environmental conditions may also affect the power requirements such as low temperatures at which the terrain surface 102 may harden and freeze, or material properties of the terrain surface 102 such as loose aggregate or a more solid substance.

Examples of passive input devices 210 that monitor operating conditions can include a machine velocity sensor 220 or speedometer that can measure and display the actual travel velocity of the mobile machine 100 with respect to the terrain surface 102. The machine velocity sensor 220 can be a rotary encoder that measures the rotational speed of the traction/propulsion devices 110 in RPM. The machine velocity sensor 220 can also be, for example, an optical or acoustic reflective sensor that directly measures the machine velocity with respect to the terrain surface by transmitting and receiving optical or acoustic waves. In an embodiment, to determine if the propulsion/traction devices 110 are spinning or slipping, the machine velocity sensors 220 can measure and compare the difference between rotational speed of the propulsion/traction devices 110 and the true machine velocity with respect to the terrain surface 102.

The input devices 210 can also include an engine sensor such as a tachometer 222 that measures the rotational output in RPM generated by the power source 120. For example, the engine sensor 222 can be a magnetic pickup sensor that measures the rotational speed of the crankshaft protruding from the power source 120. To receive additional information and data about the power requirement of the mobile machine 100, the input devices 210 may also include an electrical sensor 224 such as a voltmeter or ammeter measuring current that may associated with the electrical generator 142. As another example, the input devices 210 can include a fluid sensor 226 associated with the hydraulic pump 144 measuring the fluid pressure and/or flow rate of hydraulic fluid therefrom.

The input devices 210 can also include a load sensor 228 that can determine or estimate the operating loads applied to the mobile machine 100. Examples of operating loads can include the resistance to travel due to the mass of the machine frame 106 and the rolling resistance between the terrain surface 102 and the plurality of traction/propulsion devices 110. Operating loads can also include loads resulting from operation of the work implements, such as forces encountered when the blade 104 contacts and attempts to displace the terrain surface 102. Loads imposed by the hydraulic and/or electrical systems that can be measured by the electrical sensor 224 or fluid sensor 226 can be included with the load sensor 228. The measurements made by the load sensor 228 can correspond to the total motive force that the powertrain 122 must generate at a particular time for operation of the mobile machine 100.

To interface with an operator, the input devices 210 can include an interface device referred to as a human machine interface 230 (HMI). In an embodiment, the HMI 230 can be a visual display device including a display screen on which numerical, textual, and/or graphical information can be visually presented to an operator. The display screen of the HMI 230 can have touchscreen capabilities to receive tactile input from the operator as well. Additionally, the HMI 230 can include various keypad, buttons, switches or the like to receive input and directive commands from the operator.

To tailor regulative operation of the powertrain 122, the powertrain control system 200 can utilize powertrain characteristics 232 that may be specifications and operational information about the powertrain 122. The powertrain characteristics 232 can more specifically include primary transmission characteristics 234 associated with the primary transmission 128 and the secondary transmission characteristics 236 associated with the secondary transmission 152, as well as additional operative information about the powertrain 122. For example, the powertrain characteristics 232 can include power curves that related the power, torque, speed and timing characteristics of the primary and second transmissions 128, 152. The powertrain characteristics 232 can include information about the number of actual or virtual gear ratios or gear sets that the primary and second transmissions 128, 152 have. The powertrain characteristics 232 can be stored as computer readable data in maps and lookup tables stored in the data memory 206 of the electronic controller 202.

The powertrain control system 200 can be configured to process the data and information received from the plurality of input devices 210 and the powertrain characteristics 232 using analytical or evaluative procedures to make assessments and determinations about the operation of the powertrain 122. In particular, the electronic controller 202 can be programmed with executable software that conducts analytical operations on the data received from the input devices 210 to evaluate and determine the current operating characteristics, settings, and conditions of the powertrain 122 including the primary transmission 128 and the secondary transmission 152. The power control system 200 can also make predictive evaluations and prognoses about possible interruptions to the operation of the powertrain 122. For example, the electronic controller 202 can evaluate and determined the possible occurrence of a nonsynchronous shift or interruption in the transfer of motive force through the powertrains 122.

Referring to the chart 240 in FIG. 2, there is illustrated a power curve 242 that can be associated with the powertrain 122. The continuous time or duration of operation, i.e., operating time 244, of the powertrain 122 is represented on the X-axis and the torque 246 or motive force transmitted by the powertrains 122 can be represented on the Y-axis. The chart shows the power curve 242 increasing with operating time 244, indicating that the powertrain 122 is transmitting more torque 246. The power curve 242, however, indicates or reflects the occurrence of a nonsynchronous shift 248 or other interruption in power transmission, which is indicated by drop in the torque 246 at a particular operating time 244. The nonsynchronous shift 248 results in a reduced or interrupted power curve 250 in which powertrain 122 produces a reduced quantity of power or torque.

A nonsynchronous shift occurs when a transmission setting of, for example, the primary transmission 128 of the mobile machine 100 shifts from one gear ratio to another gear ratio. For a conventional mechanical transmission having a plurality of fixed gear sets, a nonsynchronous shift can be caused by a delay in the disengagement of a first gear set represented by the gear ratio curve 252 in dashed lines and the engagement of a second gear set represented by the gear ratio curve 254 in dashed lines. The nonsynchronous shift 248 results in an interruption of torque transmission through the powertrain during the delay in which no gear set is physically engaged. The primary transmission 128 may also subsequently shift from the gear ratio curve 254 to the gear ratio curve 252.

If the primary transmission 128 is a CVT, for example, the split-path hydromechanical transmission 130 shown in FIG. 1, a nonsynchronous shift 248 can be an inherent part of the design and operation of the primary transmission. The nonsynchronous shift 248 may also occur due to variations and variability in timing, force transfer, loading, etc. between the mechanical power transfer path 132 and a hydrostatic power transfer path 134. Another possible reason for interruptions in power transmission can be due to clutch slippage or delay.

The powertrain control system 200 is therefore programmed to predictively estimate the possible occurrence of a nonsynchronous shift 248 or power interruption based on the data input from the input devices 210. For example, the powertrain control system 200 can assess and apply the input data from the input devices 210 to empirical or historical data to predicate or estimate the nonsynchronous shift 248 or power interruption. The powertrain control system 200 can also use definitions to recognize the conditions precedent to the possible occurrence of a nonsynchronous shift 248 or power interruption.

The powertrain control system 200 can also be configured to generate one or more output commands 260 that are utilized for operation of the mobile machine 100. In particular, the electronic controller 202 can be programmed with executable software applications that receive and analyze the data from the input devices 210 according to functions, definitions, and instructions set forth in the program to generate the output commands 260 for regulating operation of the powertrain 122. For example, upon predictively estimating or recognizing the occurrence of a nonsynchronous shift 248 or interruption in power transmission, the electronic controller 202 can output, as a data signal, a nonsynchronous shift prediction command 262.

The powertrain control system 200 can also generate one or more output commands 260 to modify or regulate the operation of the powertrain 122 to address the nonsynchronous shift 248. For example, the electronic controller 202 can be programmed to generate one or more powertrain optimization commands 264 that can alter or modify the power distribution or split between the primary transmission 128 associated with the primary axle 124 and the secondary transmission 152 associated with the secondary axle 150 to maintain a more consistent throughput of motive power and thus traction being applied through the propulsion/traction devices 110. For example, the powertrain optimization commands 264 modify operation of the powertrain 122 to maintain an optimized power curve 256, shown in chart 240, and reduce or eliminate the interrupted power curve 250. Implementing the optimized power curve 256 concurrently to coincide with the nonsynchronous shift 248 eliminates the interruption in motive power and the application of traction forces by the traction/propulsion devices 110 and averts the mobile machine 100 from lugging down.

### INDUSTRIAL APPLICABILITY

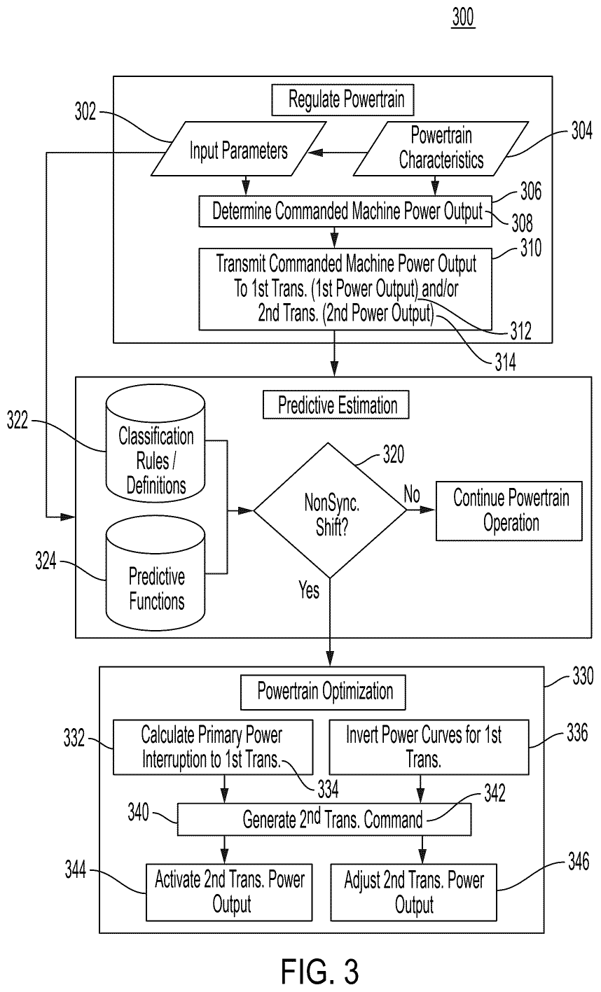

Referring to FIG. 3, with continued reference to the preceding figures, there is illustrated an embodiment of a possible routine, process, or method for regulating operation of a powertrain 122 having first and second transmissions 128, 152 to predictively estimate and address a power interruption. The described process can be implemented as non-transitory, computer-executable software programs written in any suitable programming language and run on any suitable computer architecture utilizing one or more processors and peripheral devices. The functionality described with respect to FIG. 3 can be executed on a unitary device or may be distributed among different devices, and the order and arrangement of steps can be altered, modified, or expanded.

To regulate operation of the powertrain 122, the powertrain control process 300 can utilize a plurality of input data 302 that may be received from the plurality of input devices 210 described in FIG. 2. The input data 302 can be received through active ongoing monitoring of the plurality of input devices 210 by the electronic controller 202. In some embodiments, however, the powertrain control process 300 can be initiated in response to receiving a specific or particular input data 302 that functions as an alert of the electronic controller 202. In addition to the input data 302, the powertrain control process 300 can retrieve from data memory 206 the predefined powertrain characteristic data 304 that may include specifications and operational information about the powertrain 122.

The powertrain control process 300 can, in a determination step 306 or operation determine a commanded machine power output 308 based, for example, on some of the received input data 302 and by utilizing the powertrain characteristic data 304. For example, actuation of the machine velocity control 212 may be indicative of the desired acceleration which corresponds to an increase in the commanded machine power output 308.

Actuation of the gearshift 214, for example, shifting up or down, can indicate a desired change in the torque capacity of the powertrain 122. The gearshift 214 can be actuated in response to the mobile machine 100 encountering an incline, different terrain, or a resistive load. The input data 302 received can be correlated to the powertrain characteristics 304 to produce the appropriate commands and settings of the powertrain 122 to generate commanded machine power output 308.

The commanded machine power output 308 may represent the total motive power the powertrain 122 must generate for operation of the mobile machine 100. The commanded machine power output 308 can be characterized in terms of power, torque, speed and/or duration. The powertrain control process 300 can include a transmission step 310 or operation in which commands and instructions embodied as electronic data signals are communicated to the control actuators associated with the powertrain 122 to generate the commanded machine power output 308.

In an embodiment, the transmission step 310 can be configured to distribute or split the commanded machine power output 308 between the primary and secondary transmissions 128, 152 so that the traction/propulsion devices 110 associated with the primary and secondary axles 124, 150 all deliver tractive force to the terrain surface 102. The transmission step 310 may therefore produce a primary power output 312 delivered by the primary transmission 128 and a secondary power output 314 delivered by the secondary transmission 152. The primary and secondary power outputs 312, 314 are abstract variables and the exact values may change during operation of the mobile machine 100. In another embodiment, the primary transmission 128 may deliver the entirety of the commanded machine power output 308 and the secondary transmission 152 may be inactive.

To predictively determine if a nonsynchronous shift or similar interruption to power to the traction/propulsion devices 110 may occur, the powertrain control process 300 can conduct a nonsynchronous shift decision 320. The nonsynchronous shift decision 320 can be a predictive algorithm or model that processes the commanded machine power output 308, additional input data 302 from the plurality of input devices 210, and the powertrain characteristic data 304 to predict that the primary transmission 128 will experience a nonsynchronous shift or another operational reconfiguration that may interrupt the transfer of motive force through the primary transmission 128. The result of the nonsynchronous shift decision 320 corresponds with the nonsynchronous prediction command 262 of FIG. 2.

For example, the nonsynchronous shift decision 320 can be a classification model in which the input data 302 from the input devices 210 and the powertrain characteristic data 304 are assessed and assigned to a classification or category. To classify the input data 302 from the input devices 210 and the powertrain characteristics 304, the nonsynchronous shift decision 320 can receive and apply classification definitions/rules 322. The classification definitions/rules 322 can be predefined and can include associations that direct the input data 302 into broader defined categories. The classification definitions/rules 322 can be applied to individual input data 302 or can assess the relations between multiple data items.

The classification definitions/rules 322 can also function as selection criteria for the powertrain characteristics 304. For example, the powertrain characteristics 304 can include power ratios and power ranges or limits for the primary transmission 128, including for the specific gear settings or gear ratios. Based on analysis of the input data 302, the classification definitions/rules 322 can select the powertrain characteristics 304 that correspond to the current settings for the primary transmission 128 and that can be used to predict the occurrence of a nonsynchronous shift.

The nonsynchronous shift decision 320 can then enter the input data 302 and/or powertrain characteristic data 304 as classified according to the classification definitions/rules 322 into a predictive function 324. In particular, the classified input data 302 can serve as the values for the variables and parameters of the predictive function. The predictive function 324, for example, can be a mathematical formula or equation that includes the operations to conduct on the variables and parameters and that outputs a result that is predictive of the occurrence of an event. In the powertrain control process 300, the result or output of the predictive function 324 is the determination or estimation that the primary transmission 128 will experience a nonsynchronous shift or similar power interruption. The predictive function 324 can be stored as an electronic instruction in the data memory 206 associated with the electronic controller 202 can be updated or calibrated to improve its predictive accuracy.

If the nonsynchronous shift decision 320 determines that a nonsynchronous shift is not likely to occur, operation of the powertrain 122 can continue unmodified. If, however, the nonsynchronous shift decision 320 does determine a nonsynchronous shift is likely, the powertrain control process 300 can proceed to a powertrain optimizer routine 330 to address the interruption to the transmission of motive power from the primary transmission 128. For example, the powertrain optimizer routine 330 can responsively regulate operation of the secondary transmission 152 to resolve the temporary loss or drop in motive power due to the predicted occurrence of nonsynchronous shifts or the like with the primary transmission 128. Because the nonsynchronous shift decision 320 is completed before the actual occurrence of the nonsynchronous shift 248, the powertrain optimizer routine 330 can be implemented prognostically to address and resolve the power interruption before it occurs.

In an embodiment, the powertrain optimization routine 330 can include a primary power interruption calculation 332 which quantifies the decrease or drop in motive power due to the nonsynchronous shift or similar event in the primary transmission 128. The primary power interruption 334 calculated by the primary power interruption calculation 332 can be characterized in terms of power, torques, speed and/or duration.

For example, the primary power interruption calculation 332 can determine values for the primary power output 312 of the primary transmission 128 at different operational settings, for example, using two different gear ratio curves. The powertrain characteristics 304 can include the output of power or torque with respect to speed or another variable for different configurations of the primary transmission 128. The power interruption calculation 322 can also use input data values 302 to more accurately quantify the power interruption. Comparison of the primary power output 312 for different settings of the primary transmission 128, for example, the difference between two gear ratio curves, can quantify the primary power interruption 334.

The powertrain optimization routine 330 can also include a command generation step 340 that is configured to generate commands, expressed as computer readable electronic data signals, to preemptively adjust the operational settings of the secondary transmission 152 in response to the predicted nonsynchronous shift. The command generation operation 340 can be intended to reduce or offset the calculated primary power interruption 334 with respect to the primary power output 312 of the primary transmission 128. The command generation operation corresponds to the powertrain optimization command 264 in FIG. 2.

For example, the command generation step 340 can receive the calculated primary power interruption 334 from the power interruption calculation 332 and additional powertrain characteristic data 304 specific to the operation of the secondary transmission 152. The command generation step 340 can process and analyze the received data to generate a secondary transmission command 342 that includes instructions to adjust the operational settings of the secondary transmission 152.

For example, the secondary transmission command 342 may adjust the quantity and duration of the secondary power output 314. If the secondary transmission 152 is a hydraulic motor 154, the secondary transmission command 342 can include operational settings for the fluid pressure and flowrate that produces the secondary power output 314. If the secondary transmission 152 is an electric motor 156, the secondary transmission command 342 can include limits or settings on current or motor speed that determines the secondary power output 314.

In the event the secondary transmission 152 is inactive, and the totality of the commanded machine power output 308 is provided by the primary power output 312 of the primary transmission 152, the secondary transmission command 342 can be configured as an activation command 344. For example, the activation command 344 can initiate operation of the secondary transmission 152 to generate the secondary power output 314 and transmit it to the respective propulsion/traction devices 110 coupled to the secondary axle 150.

If the secondary transmission 152 is active and producing a distributed portion of the commanded machine power output 308, the secondary transmission command 342 can be configured as an adjustment command 346 that adjusts the secondary power output 314 to supplement for the primary power interruption 334. The adjustment command 346 can increase or decrease the secondary power output 314 as appropriate. Both the activation command 344 and the adjustment command 346 can be considered to adjust the secondary power output 314.

The adjusted secondary power output 346 of the secondary transmission 152 reduces the power loss due to the primary power interruption 334, and the total motive power output of the mobile machine 100 is generally unaffected. In other words, the traction forces applied by the total plurality of traction/propulsion devices 110 remains consistent regardless of the primary power interruption 334 with the primary transmission 128. The operator of mobile machine 100 may not experience and feel a sudden lug or reduction in the motive power and tractive forces applied by the powertrain 122.

In another example, the powertrain optimizer routine 330 can directly utilize the powertrain characteristics data 304 for the primary transmission 128 to generate the secondary transmission command 342 for regulating the second transmission 152. In a curve inversion step 336, powertrain optimizer routine 330 can invert the operating characteristics of the primary transmission 128 that correspond to the nonsynchronous shift. For example, the curve inversion step 336 can partition and invert the power curves 242 shown in the chart 240 of FIG. 2 including change in torque 246 associated with the nonsynchronous shift 248. The curve inversion step 336 may add and subtract power as appropriate. The secondary transmission command 342 then directs operation of the secondary transmission 152 in a manner inversely proportional to the power curves 242 so the total motive power of the mobile machine 100 is unaffected.

An advantage of combining the predictive application of the nonsynchronous shift decision 320 is that nonsynchronous shifts are identified prior to occurrence. The powertrain control process 300 can implement the powertrain optimizer routine 330 in advance of the nonsynchronous shift 248 to adjust the secondary power output 314 concurrently with the nonsynchronous shift 248. As shown in chart 240, the optimized power curve 256 is implemented to coincide with the nonsynchronous shift 248 so that the interruption in motive power from the primary transmission 128 is reduced or eliminated.

It should be appreciated from the foregoing that the disclosure provides an advantageous way of adjusting the available rotation speeds of an internal combustion engine and thus the velocity or travel speed of a mobile machine during specific operations such as a finishing operation wherein a ground-engaging implement is used to precisely contour a work surface. These and other advantages and features of the disclosure should be apparent from the foregoing specification and accompanying drawings.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A powertrain for a mobile machine comprising:
a power source generating and transmitting motive power;
a primary axle operatively coupled to a primary traction/propulsion device for propelling the mobile machine over a terrain surface;
a primary transmission operatively coupled between the power source and the primary axle;
a secondary axle operatively coupled to a secondary traction/propulsion device for propelling the mobile machine over the terrain surface;
a secondary transmission operatively coupled to the secondary traction/propulsion device for directing a secondary power output thereto;
an electronic controller configured to receive one or more data inputs, to analyze the one or more data inputs to predictively estimate if a nonsynchronous shift will occur with the primary transmission, and to command the secondary transmission to adjust the secondary power output concurrently with the nonsynchronous shift.

2. The powertrain of claim 1, wherein the nonsynchronous shift is associated with a power interruption of a primary power output from the primary transmission.

3. The powertrain of claim 2, wherein the primary transmission is associated with a plurality of gear ratios adjusting the primary power output from the primary transmission to the primary traction/propulsion device and the nonsynchronous shift occurs during shifting between the plurality of gear ratios.

4. The powertrain of claim 3, wherein the electronic controller is configured to receive powertrain characteristics for the primary transmission to predictively estimate if the nonsynchronous shift will occur.

5. The powertrain of claim 4, wherein the electronic controller is configured to calculate a primary power interruption associated with the nonsynchronous shift.

6. The powertrain of claim 5, wherein the electronic controller generates a secondary transmission command to adjust the secondary power output based on the primary power interruption as calculated.

7. The powertrain of claim 4, wherein the electronic controller adjusts the secondary power output inversely with the power curves for the primary transmission.

8. The powertrain of claim 1, wherein the one or more data inputs includes information from one or more of a machine velocity control, a gearshift, and a load sensor.

9. The powertrain of claim 8, wherein the electronic controller calculates a commanded machine power output based the plurality of one or more data inputs.

10. The powertrain of claim 1, wherein the primary transmission is a continuously variable transmission configured with a dual-path design including a mechanical power transfer path and a hydrostatic power transfer path.

11. The powertrain of claim 1, wherein the secondary transmission includes one or more of an electric motor and hydraulic motor.

12. A method of operating a powertrain of a mobile machine including a first transmission and a second transmission, the method comprising:
receiving a plurality of data inputs corresponding to a plurality of input devices operatively associated with the mobile machine;
predictively estimating an nonsynchronous shift that will occur with the first transmission; and
adjusting a secondary power output from the secondary transmission concurrently with the nonsynchronous shift of the primary transmission.

13. The method of claim 12, further comprising calculating a primary power interruption resulting from the nonsynchronous shift of the first transmission and adjusting the secondary power output responsively to the primary power interruption as calculated.

14. The method of claims 12, further comprising retrieving powertrain characteristics including curves for the primary transmission and adjusting the secondary power output inversely to the power curves for the primary transmission.

15. The method of claim 12, wherein the one or more data inputs includes information from one or more of a machine velocity control, a gearshift, and a load sensor.

16. The method of claim 15, further comprising retrieving powertrain characteristics associated with the primary transmission.

17. The method of claim 16, wherein the step of predictively estimating the nonsynchronous shift includes applying classification definitions/rules and a predictive function to the data input and to the powertrain characteristics.

18. A powertrain control process comprising:
transmitting a primary power output from a primary transmission of a powertrain to a primary axle coupled to a primary traction/propulsion device of a mobile machine;
receiving one or more data inputs from a plurality of input devices associated with powertrain;
predictively estimating a nonsynchronous shift will occur with the primary transmission based on the one or more data inputs; and
adjusting a secondary power output from a secondary transmission of the powertrain to a secondary axle coupled to a secondary traction/propulsion device of the mobile machine concurrently with nonsynchronous shift.

19. The powertrain control process of claim 18, further comprising calculating a primary power interruption resulting from the nonsynchronous shift and adjusting the secondary power output based on the primary power interruption as calculated.

20. The powertrain control process of claim 18, wherein the step of predictively estimating the nonsynchronous shift includes applying classification definitions/rules and a predictive function to the data input and to powertrain characteristics.
